(19) United States
(12) Patent Application Publication
(10) Pub. No.: US 2006/0139260 A1
(43) Pub. Date: Jun. 29, 2006

(54) Display and array substrate

(76) Inventor: Makoto Shibusawa, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/312,761

(22) Filed: Dec. 21, 2005

(30) Foreign Application Priority Data
Dec. 27, 2004 (JP) 2004-378252

(51) Int. Cl. G09G 3/30

(52) U.S. Cl. 345/76

(57) ABSTRACT

Each pixel of a display includes a light emitting element including an anode connected to a high potential power supply terminal, a cathode, and an active layer interposed between the anode and the cathode, a drive control element including a p channel thin film transistor whose drain is connected to a low potential power supply terminal lower in electric potential than the high potential power supply terminal, an output control switch connected between the cathode and a source of the p channel thin film transistor, a capacitor connected between a gate of the p channel thin film transistor and the source, and a diode connecting switch connected between the gate and the drain.

### CROSS-REFERENCE TO RELATED APPLICATIONS

This application is based upon and claims the benefit of priority from prior Japanese Patent Application No. 2004-378252, filed Dec. 27, 2004, the entire contents of which are incorporated herein by reference.

### BACKGROUND OF THE INVENTION

1. Field of the Invention

The present invention relates to a display and array substrate and, more particularly, to an active matrix organic electroluminescent (EL) display and an array substrate used in the display.

2. Description of the Related Art

U.S. Pat. No. 6,373,454 describes an active matrix organic EL display using the following arrangement in a pixel. For example, each pixel is made up of an organic EL element, an n-channel field effect transistor, a capacitor, and first to third switches. The source of the n-channel field effect transistor is connected to a low-potential power supply terminal. The first switch and organic EL element are connected in series in this order between the drain of the n-channel field effect transistor and a high-potential power supply terminal. The second switch is connected between a video signal line and the drain of the n-channel field effect transistor. The third switch is connected between the gate and drain of the n-channel field effect transistor. Also, the capacitor is connected between the gate and source of the n-channel field effect transistor.

This active matrix organic EL display is driven by the following method. In a write period, while the first switch is opened and the second and third switches are closed, a video signal I_{sig} is output from a video signal line driver to the video signal line. In this manner, a gate-to-source voltage V_{gs} of the n-channel field effect transistor is set at a value corresponding to the video signal I_{sig}. In an effective display period following the write period, the second and third switches are opened, and the first switch is closed. Since the gate-to-source voltage V_{gs} of the n-channel field effect transistor is maintained substantially constant by the capacitor, a driving current I_{drv} having a magnitude substantially equal to the video signal I_{sig} flows through the organic EL element in the effective display period.

As is apparent from this explanation, in an organic EL display using the above arrangement in each pixel, the threshold voltage, mobility, and the like of the n-channel field effect transistor have no influence on the relationship between the magnitudes of the video signal I_{sig} and driving current I_{drv}. That is, when the above arrangement is used in a pixel, it is possible to eliminate the influence that the variations in characteristics of the n-channel field effect transistor have on the image quality. However, the prevent inventor has found that when thin film transistors are used as field effect transistors in an organic EL display having the above arrangement, an electrostatic damage readily occurs during the manufacturing process.

### BRIEF SUMMARY OF THE INVENTION

According to a first aspect of the present invention, there is provided a display comprising pixels arranged in a matrix form, wherein each of the pixels comprises a light emitting element including an anode connected to a high potential power supply terminal, a cathode, and an active layer interposed between the anode and the cathode, a drive control element including a p channel thin film transistor whose drain is connected to a low potential power supply terminal lower in electric potential than the high potential power supply terminal, an output control switch connected between the cathode and a source of the p channel thin film transistor, a capacitor connected between a gate of the p channel thin film transistor and the source, and a diode connecting switch connected between the gate and the drain.

According to a second aspect of the present invention, there is provided a display comprising pixels arranged in a matrix form, wherein each of the pixels comprises a light emitting element including an anode, a cathode connected to a low potential power supply terminal, and an active layer interposed between the anode and the cathode, a drive control element including an n channel thin film transistor whose drain is connected to a high potential power supply terminal higher in electric potential than the low potential power supply terminal, an output control switch connected between the anode and a source of the n channel thin film transistor, a capacitor connected between a gate of the n channel thin film transistor and the source, and a diode connecting switch connected between the gate and the drain.

According to a third aspect of the present invention, there is provided an array substrate comprising pixel circuits arranged in a matrix form, wherein each of the pixel circuits comprises a cathode of a light emitting element, a drive control element including a p channel thin film transistor whose drain is connected to a power supply terminal, an output control switch connected between the cathode and a source of the p channel thin film transistor, a capacitor connected between a gate of the p channel thin film transistor and the source, and a diode connecting switch connected between the gate and the drain.

According to a fourth aspect of the present invention, there is provided an array substrate comprising pixel circuits arranged in a matrix form, wherein each of the pixel circuits comprises an anode of a light emitting element, a drive control element including an n channel thin film transistor whose drain is connected to a power supply terminal, an output control switch connected between the anode and a source of the n channel thin film transistor, a capacitor connected between a gate of the n channel thin film transistor and the source, and a diode connecting switch connected between the gate and the drain.

### BRIEF DESCRIPTION OF THE SEVERAL VIEWS OF THE DRAWING

FIG. 1 is a plan view schematically showing a display according to the first embodiment of the present invention;

FIG. 2 is a sectional view showing an example of a structure usable as the display shown in FIG. 1;

FIG. 3 is a timing chart schematically showing an example of a method of driving the display shown in FIG. 1;

FIG. 4 is an equivalent circuit diagram of the pixel included in the display shown in FIG. 1;

FIG. 5 is an equivalent circuit diagram of a pixel included in a display according to a comparative example;

FIG. 6 is a plan view schematically showing a display according to the second embodiment of the present invention; and

FIG. 7 is an equivalent circuit diagram of a pixel included in the display shown in FIG. 6.

### DETAILED DESCRIPTION OF THE INVENTION

Several embodiments of the present invention will be described in detail below with reference to the accompanying drawing. Note that the same reference numerals in the drawing denote constituent elements which achieve the same or similar functions, and an repetitive explanation thereof will be omitted.

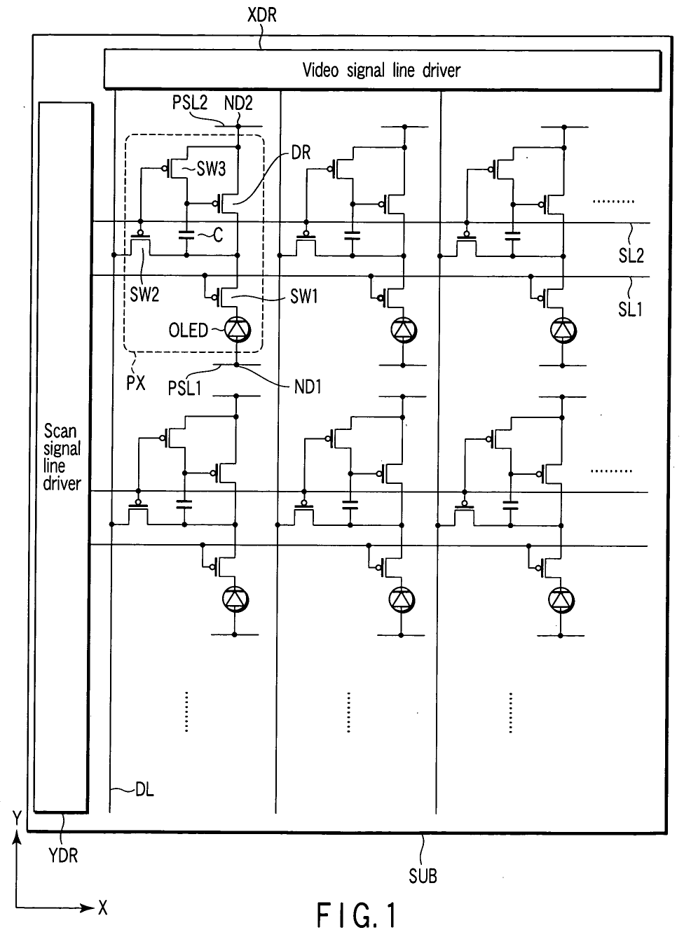

FIG. 1 is a plan view schematically showing a display according to the first embodiment of the present invention. This display is an organic EL display employing an active matrix driving method, and includes a plurality of pixels PX. The pixels PX are arranged in a matrix form on an insulating substrate SUB such as a glass substrate.

A scan signal line driver YDR and video signal line driver XDR are mounted on the substrate SUB.

On the substrate SUB, scan signal lines SL1 and SL2 connected to the scan signal line driver YDR run in the row direction (X direction) of the pixels PX. The scan signal line driver YDR supplies scan signals as voltage signals to the scan signal lines SL1 and SL2.

Also, on the substrate SUB, video signal lines DL connected to the video signal line driver XDR run in the column direction (Y direction) of the pixels PX. The video signal line driver XDR supplies video signals to the video signal lines DL.

In addition, first and second power supply lines PSL1 and PSL2 are arranged on the substrate SUB.

Each pixel PX includes a pixel circuit and light-emitting element OLED. The pixel circuit includes a drive control element DR, output control switch SW1, video signal supply control switch SW2, diode-connecting switch SW3, and capacitor C.

In this embodiment, the light-emitting element OLED is an organic EL element, and includes an anode, a cathode facing the anode, and an organic layer which is an active layer interposed between the anode and cathode. The organic layer of the organic EL element OLED includes an emission layer. The anode of the organic EL element is connected to the power supply line PSL1. Note that a node ND1 on the power supply line PSL1 is a high-potential power supply terminal.

The drive control element DR is, e.g., a p-channel thin film transistor in which a source, drain, and channel are formed in a polycrystalline semiconductor layer such as a polysilicon layer. The drain of the drive control element DR is connected to the power supply line PSL2. Note that a node ND2 on the power supply line PSL2 is a low-potential power supply terminal.

The output control switch SW1 is connected between the cathode of the organic EL element OLED and the source of the drive control element DR. A switching operation of the output control switch SW1 is controlled by, e.g., a scan signal supplied from the scan signal line driver YDR via the scan signal line SL1. In this embodiment, a p-channel thin film transistor is used as the output control switch SW1 as an example. The gate of this p-channel thin film transistor is connected to the scan signal line SL1.

The video signal supply control switch SW2 is connected between the video signal line DL and the source of the drive control element DR. A switching operation of the video signal supply control switch SW2 is controlled by, e.g., a scan signal supplied from the scan signal line driver YDR via the scan signal line SL2. In this embodiment, a p-channel thin film transistor is used as the video signal supply control switch SW2 as an example. The gate of this p-channel thin film transistor is connected to the scan signal line SL2.

The diode-connecting switch SW3 is connected between the drain and gate of the drive control element DR. A switching operation of the diode-connecting switch SW3 is controlled by, e.g., a scan signal supplied from the scan signal line driver YDR via the scan signal line SL2. In this embodiment, a p-channel thin film transistor is used as the diode-connecting switch SW3 as an example. The gate of this p-channel thin film transistor is connected to the scan signal line SL2.

The capacitor C is connected between the source and gate of the drive control element DR. The capacitor C holds the gate-to-source voltage of the drive control element DR substantially constant during a display period following a write period.

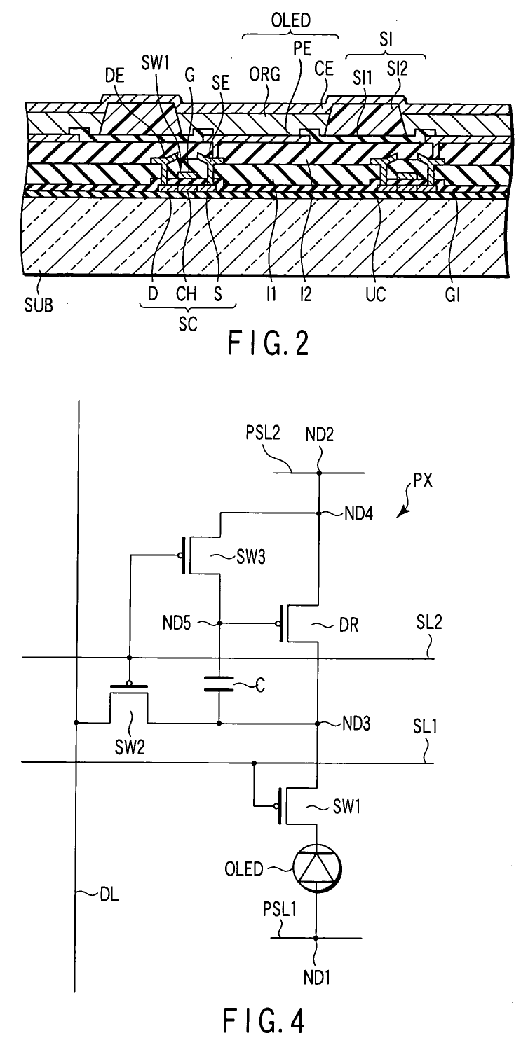

FIG. 2 is a sectional view showing an example of a structure usable in the display shown in FIG. 1. Although FIG. 2 shows only the output control switch SW1 as a thin film transistor, the video signal supply control switch SW2 and diode-connecting switch SW3 have the same structure as the output control switch SW1. Also, the drive control element DR has substantially the same structure as the output control switch SW1.

As shown in FIG. 2, an undercoat layer UC is formed on one main surface of the insulating substrate SUB. As the undercoat layer UC, it is possible to use, e.g., a stacked structure of an SiNₓ layer and SiO₂ layer.

Patterned semiconductor layers SC are arranged on the undercoat layer UC. The semiconductor layers SC are, e.g., polysilicon layers in each of which a source S and drain D of a thin film transistor are formed away from each other. A region CH between the source S and drain D in the semiconductor layer SC is used as a channel.

A gate insulator GI is formed on the semiconductor layers SC. A first conductor pattern and an insulating film I1 are sequentially formed on the gate insulator GI. The first conductor pattern is used as the gates G of the thin film transistors, first electrodes (not shown) of the capacitors C, the scan signal lines SL1 and SL2, and interconnections connecting these components. Also, the insulating film I1 is used as an interlayer dielectric film and as a dielectric layer of the capacitor C.

A second conductor pattern is formed on the insulating film I1. The second conductor pattern is used as source electrodes SE, drain electrodes DE, second electrodes (not shown) of the capacitors C, the video signal lines DL, the power supply lines PSL2, and interconnections connecting these components. The source electrode SE and drain electrode DE are connected to the source S and drain D, respectively, of the thin film transistor at the positions of through holes formed in the insulating films GI and I1.

An insulating film I2 and a third conductor pattern are sequentially formed on the second conductor pattern and the insulating film I1. The insulating film I2 is used as a passivation film and/or a planarizing layer. The third conductor pattern is used as a pixel electrode PE, i.e., a cathode, of each organic EL element OLED.

In the insulating film I2, a through hole which communicates with the source electrode SE connected to the source S of the output control switch SW1 is formed for each pixel PX. Each pixel electrode PE covers the sidewall and bottom surface of this through hole, thereby connected to the source S of the output control switch SW1 via the source electrode SE.

A partition insulating layer SI is formed on the insulating film I2. In this embodiment, the partition insulating layer SI has a stacked structure including an inorganic insulating layer SI1 and organic insulating layer SI2 as an example. The inorganic insulating layer SI1 may be omitted.

In the partition insulating layer SI, through holes are formed at the positions of the pixel electrodes PE. In each through hole of the partition insulating layer SI, an organic layer ORG including an emission layer covers the pixel electrode PE. The emission layer is, e.g., a thin film containing a luminescent organic compound which emits red, green, or blue light. The organic layer ORG may include, e.g., a hole injection layer, hole transporting layer, electron injection layer, and electron transporting layer, in addition to the emission layer. These layers included in the organic layer ORG can be formed by, e.g., mask evaporation or the inkjet process.

A common electrode CE, i.e., an anode, is formed on the partition insulating layer SI and organic layers ORG. The common electrode CE is electrically connected to a power supply line which provides the node ND1, via a contact hole (not shown) formed in the insulating films I2 and I2 and the partition insulating layer SI.

Each organic EL element OLED is made up of the pixel electrode PE, organic layer ORG, and common electrode CE.

Note that in this display, the substrate SUB, the pixel electrodes PE, and the members interposed between them form an array substrate. As shown in FIG. 1, this array substrate can further include the partition insulating layer SI, scan signal line driver YDR, video signal line driver XDR, and the like.

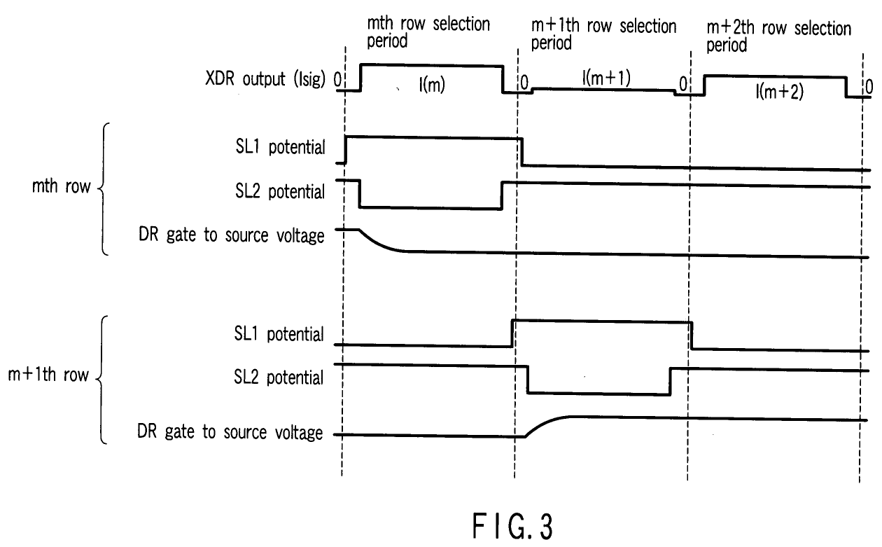

FIG. 3 is a timing chart schematically showing an example of a method of driving the display shown in FIG. 1.

Referring to FIG. 3, the abscissa represents the time, and the ordinate represents the magnitude of an electric potential or electric current. Also, referring to FIG. 3, a waveform indicated by “XDR output (I_{sig})” represents an electric current which the video signal line driver XDR supplies to a certain video signal line DL. Waveforms indicated by “SL1 potential” and “SL2 potential” represent the electric potentials of the scan signal lines SL1 and SL2, respectively. A waveform indicated by “DR gate to source voltage” represents the gate-to-source voltage of the drive control element DR.

According to the method shown in FIG. 3, the organic EL display shown in FIG. 1 is driven as follows.

To display a certain gray level by the pixel PX on the mth row, in a period during which the pixel PX on the mth row is selected, i.e., in an mth row select period, the output control switch SW1 is opened by, e.g., changing the electric potential of the scan signal line SL1 from a second potential as a low potential to a first potential as a high potential. In a write period during which the output control switch SW1 is open, the following write operation is performed.

That is, first, the video signal supply control switch SW2 and diode-connecting switch SW3 are closed by, e.g., changing the electric potential of the scan signal line SL2 from the first potential to the second potential. In this manner, the video signal line DL and the source of the drive control element DL are connected, and the drain and gate of the drive control element DR are connected.

In this state, a video signal is supplied from the video signal line driver XDR to the selected pixel PX via the video signal line DL. That is, the video signal line driver XDR supplies an electric current I_{sig} from the video signal line DL to the power supply terminal ND2. The magnitude of the electric current I_{sig} corresponds to the magnitude of a driving current I_{drv} to be supplied to the display element OLED of the selected pixel PX, i.e., the gray level to be displayed by the selected pixel PX.

When this write operation is performed, the gate-to-source voltage of the drive control element DR is set at a value V_{gs} obtained when the electric current I_{sig} flows through the source-to-drain path of the drive control element DR.

Then, the video signal supply control switch SW2 and diode-connecting switch SW are opened by, e.g., changing the electric potential of the scan signal line SL2 from the second potential to the first potential. That is, the video signal line DL and drive control element DR are disconnected from each other, and the drain and gate of the drive control element DR are disconnected from each other. Subsequently, the output control switch SW1 is closed by changing the electric potential of the scan signal line SL1 from the first potential to the second potential.

As described above, the write operation sets the gate-to-source voltage of the drive control element DR at the value obtained when the electric current I_{sig} flows. The gate-to-source voltage V_{gs} is maintained until the video signal supply control switch SW2 and diode-connecting switch SW3 are closed. In the effective display period, therefore, the drive control element DR controls the driving current I_{drv} flowing through the display element OLED to have a magnitude corresponding to the electric current I_{sig}. As a consequence, the display element OLED displays a gray level corresponding to the magnitude of the driving current I_{drv}.

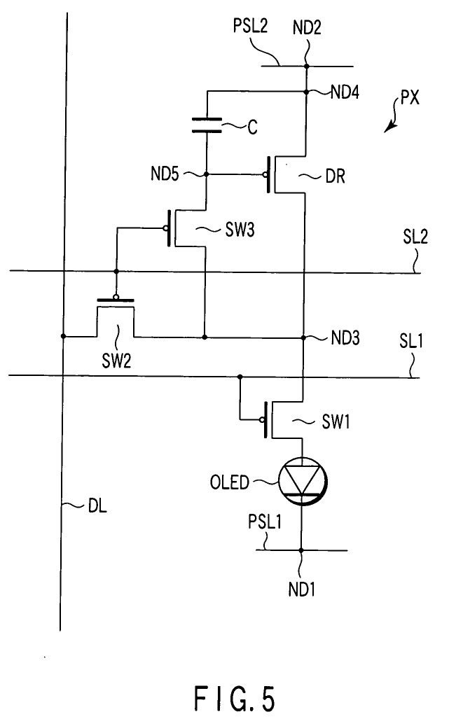

This organic EL display hardly suffers any electrostatic damage during the manufacturing process. This will be explained below by comparing FIGS. 4 and 5.

FIG. 4 is an equivalent circuit diagram of the pixel included in the display shown in FIG. 1. FIG. 5 is an equivalent circuit diagram of a pixel included in a display according to a comparative example.

Referring to FIG. 4, the node ND1 is a high-potential power supply terminal, and the node ND2 is a low-potential power supply terminal. The anode and cathode of the organic EL element OLED are connected to the power supply line PSL1 and the source of the output control switch SW1, respectively. The capacitor C is connected between a node ND3 and the gate of the drive control element DR. The diode-connecting switch SW3 is connected between a node ND4 and the gate of the drive control element DR.

By contrast, referring to FIG. 5, the node ND1 is a low-potential power supply terminal, and the node ND2 is a high-potential power supply terminal. The cathode and anode of the organic EL element OLED are connected to the power supply line PSL1 and the drain of the output control switch SW1, respectively. The capacitor C is connected between the node ND4 and the gate of the drive control element DR. The diode-connecting switch SW3 is connected between the node ND3 and the gate of the drive control element DR.

In the pixel PX shown in FIG. 5, the video signal supply control switch SW2 and diode-connecting switch SW3 are present on a conduction path connecting a node ND5 and the video signal line DL. The diode-connecting switch SW3 and drive control element DR are present on a conduction path connecting the node ND5 and power supply line PSL2 via the node ND3. The capacitor C is present on a conduction path connecting the node ND5 and power supply line PSL2 without the node ND3 between them. The diode-connecting switch SW3, output control switch SW1, and organic EL element OLED are present on a conduction path connecting the node ND5 and power supply line PSL1. Note that the node N5 is not connected to the scan signal lines SL1 and SL2.

In the pixel PX shown in FIG. 5 as described above, the capacitor C or two thin film transistors is present on each conduction path connecting the node ND5 and an interconnection which connects the pixel circuit to an external circuit, e.g., the video signal line driver XDR, scan signal line driver YDR, or a power supply circuit (not shown). Therefore, when no scan signals are supplied to the scan signal lines SL1 and SL2, the electric charge hardly moves between the node ND5 and the interconnection described above. That is, when the structure shown in FIG. 5 is used as the pixel PX, a high voltage may be applied between, e.g., the nodes ND4 and ND5 or between the node ND5 and scan signal line SL2, during the manufacturing process.

If a high voltage is applied between the node ND5 and the node ND4 or between the node ND5 and the scan signal line SL2, a short circuit may occur between the gate and source of the drive control element DR, the electrodes of the capacitor C, or the gate and drain of the diode-connecting switch SW3. Accordingly, when the structure shown in FIG. 5 is used as the pixel PX, an electrostatic damage readily occurs during the manufacturing process.

By contrast, in the pixel PX shown in FIG. 4, only the diode-connecting switch SW3 is present on the conduction path connecting the node ND5 and power supply line PSL2. Also, any other node in the pixel circuit is connected to the scan signal line SL1 or SL2, power supply line PSL1 or PSL2, or video signal line DL via one or no thin film transistor. In the pixel PX shown in FIG. 4, therefore, when compared with the pixel PX shown in FIG. 5, the electric charge easily moves between the node and the above-mentioned interconnection in the pixel PX when no scan signals are supplied to the scan signal lines SL1 and SL2. Accordingly, an electrostatic damage occurs more hardly when the structure shown in FIG. 4 is used as the pixel PX than when the structure shown in FIG. 5 is used as the pixel PX.

In addition, in the pixel PX shown in FIG. 4, no auxiliary capacitance line is necessary because the capacitor C is connected between the gate and source of the drive control element DR. When compared with a structure including an auxiliary capacitance line, therefore, it is possible to increase the emission area and prolong the life of the organic EL element OLED.

The second embodiment of the present invention will be described below.

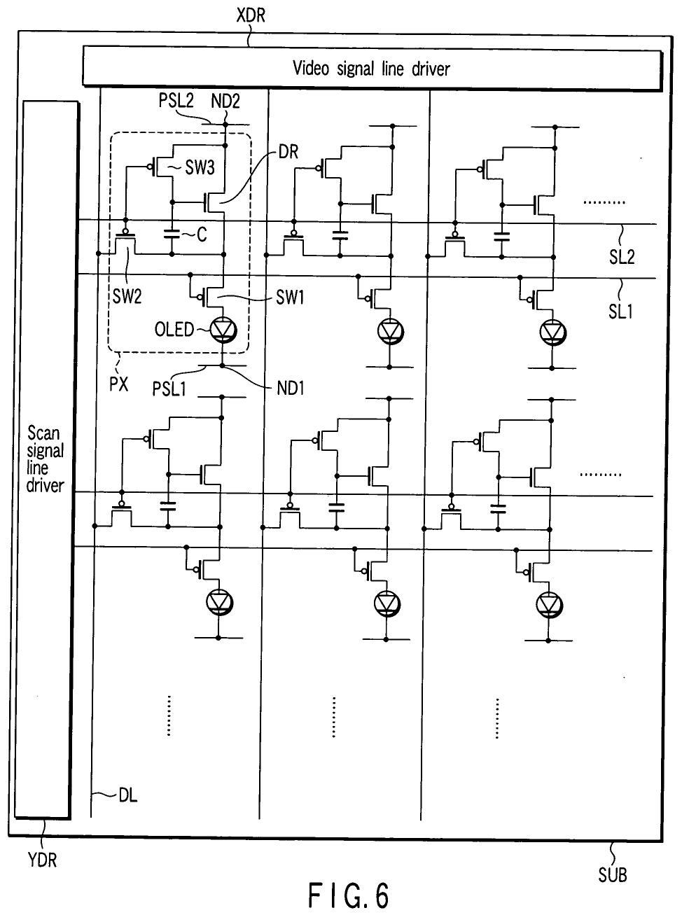

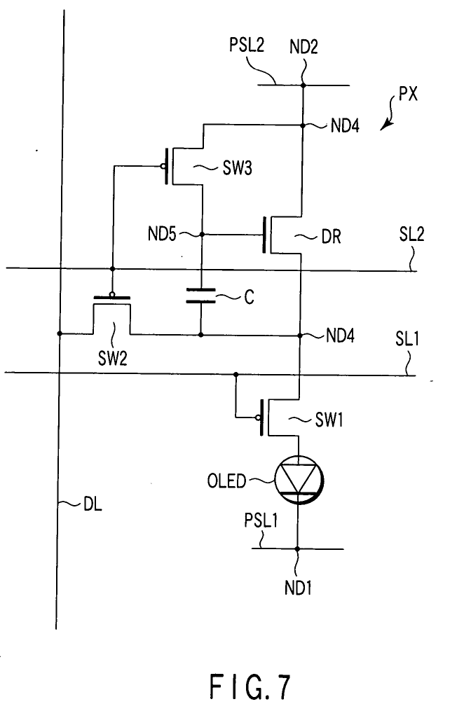

FIG. 6 is a plan view schematically showing a display according to the second embodiment of the present invention. FIG. 7 is an equivalent circuit diagram of a pixel included in the display shown in FIG. 6.

This display is an organic EL display in which a node ND1 is a low-potential power supply terminal, and a node ND2 is a high-potential power supply terminal. Also, an n-channel thin film transistor is used as a drive control element DR. Furthermore, the anode and cathode of an organic EL element OLED are connected to an output control switch SW1 and the node ND1, respectively. The rest of the structure of the organic EL display according to this embodiment is substantially the same as that of the organic EL display according to the first embodiment.

As shown in FIG. 7, only a diode-connecting switch SW3 is present on a conduction path connecting a node ND5 and power supply line PSL2 in this organic EL display as well. Also, any other node in the pixel circuit is connected to a scan signal line SL1 or SL2, a power supply line PSL1, the power supply line PSL2, or a video signal line DL via one or no thin film transistor. Therefore, as the organic EL display according to the first embodiment, this organic EL display also resists electrostatic damage during the manufacturing process.

In the first and second embodiments, p-channel thin film transistors are used as the output control switch SW1, video signal supply control switch SW2, and diode-connecting switch SW3. However, n-channel thin film transistors may be used as these switches.

Also, the first and second embodiments use the arrangement in which the current signal I_{sig} is supplied as a video signal to the pixel PX. However, the present invention is also applicable to an organic EL display in which a voltage signal V_{sig} is applied as a video signal to the pixel PX. For example, in the pixel PX shown in FIG. 4 or 7, it is possible to connect the video signal supply control switch SW2 and a capacitor (not shown) in series in this order between the video signal line DL and node ND5, instead of connecting the video signal supply control switch SW2 between the video signal line DL and node ND3. In this case, a scan signal line for controlling a switching operation of the video signal supply control switch SW2 is formed in addition to the scan signal lines SL1 and SL2.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display comprising pixels arranged in a matrix form, wherein each of the pixels comprises:
a light emitting element including an anode connected to a high potential power supply terminal, a cathode, and an active layer interposed between the anode and the cathode;
a drive control element including a p channel thin film transistor whose drain is connected to a low potential power supply terminal lower in electric potential than the high potential power supply terminal;
an output control switch connected between the cathode and a source of the p channel thin film transistor;
a capacitor connected between a gate of the p channel thin film transistor and the source; and
a diode connecting switch connected between the gate and the drain.

2. The display according to claim 1, wherein each of the pixels further comprises a video signal supply control switch connected between the source and a video signal line.

3. The display according to claim 1, wherein the light emitting element is an organic EL element.

4. The display according to claim 1, wherein the display is configured to supply each of the pixels with a current signal as a video signal.

5. The display according to claim 1, wherein the display is configured to supply each of the pixels with a voltage signal as a video signal.

6. A display comprising pixels arranged in a matrix form, wherein each of the pixels comprises:
a light emitting element including an anode, a cathode connected to a low potential power supply terminal, and an active layer interposed between the anode and the cathode;
a drive control element including an n channel thin film transistor whose drain is connected to a high potential power supply terminal higher in electric potential than the low potential power supply terminal;
an output control switch connected between the anode and a source of the n channel thin film transistor;
a capacitor connected between a gate of the n channel thin film transistor and the source; and
a diode connecting switch connected between the gate and the drain.

7. The display according to claim 6, wherein each of the pixels further comprises a video signal supply control switch connected between the source and a video signal line.

8. The display according to claim 6, wherein the light emitting element is an organic EL element.

9. The display according to claim 6, wherein the display is configured to supply each of the pixels with a current signal as a video signal.

10. The display according to claim 6, wherein the display is configured to supply each of the pixels with a voltage signal as a video signal.

11. An array substrate comprising pixel circuits arranged in a matrix form, wherein each of the pixel circuits comprises:
a cathode of a light emitting element;
a drive control element including a p channel thin film transistor whose drain is connected to a power supply terminal;
an output control switch connected between the cathode and a source of the p channel thin film transistor;
a capacitor connected between a gate of the p channel thin film transistor and the source; and
a diode connecting switch connected between the gate and the drain.

12. The array substrate according to claim 11, wherein each of the pixel circuits further comprises a video signal supply control switch connected between the source and a video signal line.

13. An array substrate comprising pixel circuits arranged in a matrix form, wherein each of the pixel circuits comprises:
an anode of a light emitting element;
a drive control element including an n channel thin film transistor whose drain is connected to a power supply terminal;
an output control switch connected between the anode and a source of the n channel thin film transistor;
a capacitor connected between a gate of the n channel thin film transistor and the source; and
a diode connecting switch connected between the gate and the drain.

14. The array substrate according to claim 13, wherein each of the pixel circuits further comprises a video signal supply control switch connected between the source and a video signal line.
